(19) United States
(12) Patent Application Publication
(10) Pub. No.: US 2019/0362627 A1
(43) Pub. Date: Nov. 28, 2019

(54) ESTIMATION DEVICE, ESTIMATION SYSTEM, ESTIMATION METHOD, AND PROGRAM

(71) Applicant: MITSUBISHI HEAVY INDUSTRIES, LTD., Tokyo (JP)

(72) Inventors: Kazuki YOSHIDA, Tokyo (JP); Shinya KANEMORI, Tokyo (JP)

(21) Appl. No.: 16/417,980

(22) Filed: May 21, 2019

(30) Foreign Application Priority Data
May 24, 2018 (JP) 2018-099839

(51) Int. Cl. G08G 1/0967; B60W 40/09

(52) U.S. Cl. CPC G08G 1/09675; B60W 40/09

(57) ABSTRACT

A sampling unit samples an actual measurement value related to a driving result during a period of a driving under a known driving condition in order to process a material having different properties for each time zone. A driving result estimation unit obtains an estimated value related to the driving result from a value of the known driving condition and a value of an unknown driving condition. A condition estimation unit estimates the value of the unknown driving condition so that a difference between the actual measurement value related to the driving result and the estimated value related to the driving result is reduced.

### BACKGROUND OF THE INVENTION

### Field of the Invention

The present disclosure relates to an estimation device, an estimation system, an estimation method, and a program.

### Description of Related Art

Patent Document 1 discloses a technique for diagnosing a state amount of an unknown plant that is difficult to measure, on the basis of a simulator that expresses a behavior of a plant. According to Patent Document 1, the state of a plant is diagnosed by obtaining a parameter value at which a deviation between an analysis value and an actual measurement value becomes a minimum.

### CITATION LIST

### Patent Document

[Patent Document 1] Japanese Patent No. 3094191

### SUMMARY OF THE INVENTION

In order to obtain an unknown driving condition of an object of a target device using a model such as a simulator, various parameters are required to be input to the model. The parameters input to the model include a parameter related to a process target by the target device, a parameter related to an operation of an operator for the target device, and the like. These parameters are not necessarily constant values, and the values may individually vary. Therefore, the influence of this variation is also included in the unknown driving condition of the object output trout the model, and there is a possibility that the unknown driving condition of the object is not able to be obtained with high accuracy.

At least one embodiment of the present invention has been made in view of the above-described circumstances, and an object of the at least one embodiment of the present invention is to provide an estimation device, an estimation system, an estimation method, and a program capable of estimating an unknown driving condition of an object by suppressing an influence of a parameter including a variation.

According to a first aspect of the present invention, an estimation device is an estimation device that estimates a value of an unknown driving condition of a target device on the basis of a value of a known driving condition of the target device. The estimation device includes a sampling unit configured to sample an actual measurement value related to a driving result during a period of a driving under the known driving condition in order to process a material having different properties for each time zone, a driving result estimation unit configured to obtain an estimated value related to the driving result from the value of the known driving condition and the value of the unknown driving condition, and a condition estimation unit configured to estimate the value of the unknown driving condition so that a difference between the actual measurement value related to the driving result and the estimated value related to the driving result is reduced.

According to a second aspect of the present invention, the estimation device according to the first aspect may further include a subset generation unit configured to generate a plurality of sets of subsets that are a combination of the actual measurement values of which the number is less than the number of samples of the actual measurement values from a plurality of the sampled actual measurement values, and a condition calculation unit configured to calculate the value of the unknown driving condition so that the difference between the actual measurement value related to the driving result and the estimated value related to the driving result is reduced, for each of the plurality of sets of subsets. The condition estimation unit may estimate the value of the unknown driving condition on the basis of statistic of the value of the unknown driving condition calculated for each of the subsets.

According to a third aspect of the present invention, in the estimation device according to the second aspect, the condition estimation unit may generate a histogram on the basis of the value of the unknown driving condition calculated for each of the subsets, and estimate the value of the unknown driving condition on the basis of a mode of the histogram.

According to a fourth aspect of the present invention, the estimation device accordion to any of the first to third aspects may further include an alarm output unit configured to output an alarm by comparing the estimated value of the unknown driving condition with a predetermined threshold value.

According to a fifth aspect of the present invention, in the estimation device according to any of the first to fourth aspects, the condition estimation unit may estimate the value of the unknown driving condition on the basis of the actual measurement value sampled between a previous replacement timing and a current replacement timing in a timing when part of the target device is replaced.

According to a sixth aspect of the present invention, in the estimation device according to any of the first to fifth aspects, the driving result estimation unit may obtain the estimated value related to the driving result by inputting the value of the known driving condition and the value of the value of the unknown driving condition to a model that obtains the driving results on the basis of the known driving condition and unknown driving condition.

According to a seventh aspect of the present invention, in the estimation device according to any of the first to sixth aspects, the target device may be a rolling mill that rolls a rolling target by a roll, the unknown driving condition may include a parameter related to a state of the target device and a parameter related to an individual of the rolling target, and the driving result may be a parameter related to an operation amount for tilting the roll.

According to an eighth aspect of the present invention, in the estimation device according to the seventh aspect, the driving result may include at least one of leveling of left and right of the roll, and a load applied to the left and right of the roll.

According to a ninth aspect of the present invention, an estimation system includes the estimation device according to any of the first to eighth aspects, and a display device configured to display the value of the unknown driving condition estimated by the estimation device.

According to a tenth aspect of the present invention, an estimation method is an estimation method at estimating a value of an unknown driving condition of a target device on the basis of a known driving condition of the target device. The estimation method includes a step of sampling an actual measurement value related to a driving result during a period of a driving under the known driving condition in order to process a material having different properties for each time zone, a step of obtaining an estimated value related to the driving result from the value of the known driving condition and the value of the unknown driving condition, and a step of estimating the value of the unknown driving condition so that a difference between the actual measurement value related to the driving result and the estimated value related to the driving result is reduced.

According to an eleventh aspect of the present invention, a program causes a computer to execute a step of sampling an actual measurement value related to a driving result during a period of a driving under a known driving condition of a target device in order to process a material having different properties for each time zone, a step of obtaining an estimated value related to the driving result of the target device from the value of the known driving condition and a value of an unknown driving condition of the target device, and a step of estimating the value of the unknown driving condition so that a difference between the actual measurement value related to the driving result and the estimated value related to the driving result is reduced.

According to at least one of the aspects described above, the estimation device is able to estimate an unknown driving condition of an object by suppressing an influence of a parameter including a variation.

### BRIEF DESCRIPTION OF THE DRAWINGS

FIG. 1 is a diagram showing a constitution of a rolling system according to at least one embodiment of the present invention.

FIG. 2 is a diagram showing a difference between fluctuation characteristics of a long lifetime part parameter and a short lifetime part parameter.

FIG. 3 is a schematic block diagram showing a software constitution of a diagnosis device according to at least one embodiment of the present invention.

FIG. 4 is a block diagram showing an outline of equipment diagnosis according to at least one embodiment of the present invention.

FIG. 5 is a flowchart showing a diagnosis process of a rolling mill by the diagnosis device according to at least one embodiment of the present invention.

FIG. 6 is a schematic block diagram showing a constitution of a computer according to at least one embodiment of the present invention.

### DETAILED DESCRIPTION OF THE INVENTION

### First Embodiment

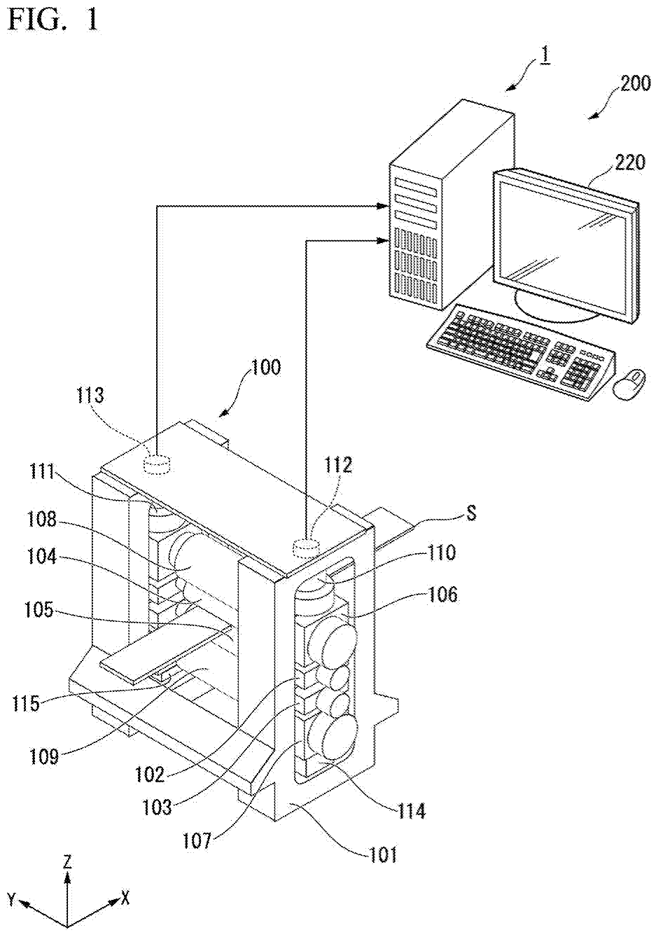

FIG. 1 is a diagram showing a constitution of a rolling system according to the first embodiment.

The rolling system 1 according to the first embodiment includes a rolling mill 100 and a diagnosis device 200. The rolling mill 100 applies a load to a metal plate and rolls the metal plate to a predetermined plate thickness. The diagnosis device 200 diagnoses the presence or absence of an abnormality of the rolling mill 100. The diagnosis device 200 includes a display 220 and displays a diagnostic result on the display 220. The rolling mill 100 is an example of a target device. In addition, the diagnosis device 200 is an example of an estimation device that estimates a value of an unknown driving condition of the rolling mill 100. The display 220 is an example of a display device. The diagnosis device 200 including the display 220 is an example of an estimation system. Note that the display 220 may be provided separately from the diagnosis device 200. In this case, a combination of the display 220 and the diagnosis device 200 is an example of an estimation system.

### Constitution of Rolling Mill

The rolling mill 100 includes a housing 101, an upper work roll chock 102, a lower work roll chock 103, an upper work roll 104, a lower work roll 105, an upper backup roll chock 106, a lower backup roll chock 107, an upper backup roll 108, a lower backup roll 109, a right pressure cylinder 110, a left pressure cylinder 111, a right stroke sensor 112, and a left stroke sensor 113.

The housing 101 is a case that forms an outer shell of the rolling mill 100.

The upper work roll chock 102 is supported by the housing 101. A shaft portion of the upper work roll 104 is rotatably supported by the upper work roll chock 102.

The lower work roll chock 103 is supported by the housing 101 below the upper work roll chock 102. A shaft portion of the lower work roll 105 is rotatably supported by the lower work roll chock 103. The upper work roll 104 and the lower work roll 105 are provided to face each other.

In the present embodiment, a vertical direction (Z-axis direction) refers to a direction in which the rolls overlap.

The upper backup roll chock 104 is supported by the housing 101 above the upper work roll chock 102. Shaft portions of the upper backup roll 108 is rotatably supported by the upper backup roll chock 106. The upper backup roll 108 and the upper work roll 104 are provided to thee each other.

The lower backup roll chock 107 is supported by the housing 101 below the lower work roll chock 103. A shaft portion of the lower backup toll 109 is rotatably supported by the lower backup roll chock 107. The lower backup roll 109 and the lower work roll 105 are provided to face each other.

The upper work roll 104, the lower work roll 105, the upper backup roll 108, and the lower backup roll 109 are short lifetime parts, and are replaced each time a predetermined number of strips S are rolled. Note that a replacement frequency of the backup roll is less than a replacement frequency of the work rod. For example, the work roll is replaced 60 to 100 times during a to place interval of the backup roll. On the other hand, the upper work roll chock 102, the lower work roll chock 103, the upper backup roll chock 106, and the lower backup roll chock 107 are long lifetime parts as compared with the roll, and are not frequently replaced.

The right pressure cylinder 110 is provided on an upper portion of the housing 101. The right pressure cylinder 110 applies a load to a right end portion of the upper backup roll chock 106. The right pressure cylinder 110 applies a rolling load to the upper work roll 104 through the upper backup roll 108.

The left pressure cylinder 111 is provided on an upper portion of the housing 101. The left pressure cylinder 111 applies a load to the left end portion of the upper backup roll chock 106 from. The left pressure cylinder 111 applies a rolling load to the upper work roll 104 through the upper backup roll 108.

In the present embodiment, a left-right direction (Y-axis direction) refers to a direction in which the axis of the roll extends.

The right stroke sensor 112 measures a stroke amount of the right pressure cylinder 110.

The left stroke sensor 113 measures a stroke amount of the left pressure cylinder 111.

The operator inserts the strip S from an input side of the housing 101 and applies the load by the right pressure cylinder 110 and the left pressure cylinder 111. The load applied by the right pressure cylinder 110 and the left pressure cylinder 111 is transferred to the upper backup roll 108. The rolling load is given to the strip S when the strip S passes between the upper work roll 104 and the lower work roll 105. Therefore, the strip S is rolled to a predetermined thickness.

When the strip S is rolled by the rolling mill 100, the rolled strip S may pass off a center of the rolling mill 100. This state is referred to as “meandering”. The operator adjusts leveling amounts of the right pressure cylinder 110 and the left pressure cylinder 111 so as to suppress the meandering of the strip S by visual observation.

The meandering of the strip S occurs when a roll gap is different on the left and right. The roll gap is a gap between the upper work roll 104 and the lower work roll 105. That is, when the roll gap of one side is smaller than the roll gap of the other side, the meandering of the strip S occurs because the one side of the strip S extends relatively to the ether side of the strip S. The meandering of the strip S occurs when a plate thickness of the strip S before rolling is different on the left and right even though the roll gap is even. When the plate thickness of the strip S different on the left and right, a difference of elastic deformation occurs on the left and right of the upper work roll 104 and the lower work roll 105 by the pressures of the upper work roll 104 and the lower work roll 105, as a result the roll gap occurs and the meandering occurs in the strip S.

examples of the cause of the left and right difference of the roll gap may include, a left and right wear difference of the roll chock, a rigidity difference between the left and right of the roll, a deviation of an installation position of the roll, a temperature difference in a width direction of the strip S, a meandering amount of the strip S, and a plate thickness difference in the width direction of strip S. The wear amount of the roll chock is an example of the long lifetime part parameter. The rigidity difference between the left and right of the roll and the deviation amount of the installation position of the roll are examples of the short lifetime part parameter. The temperature difference in the width direction of the strip S, the meandering amount of the strip S, a deviation amount of an insertion position of the strip S, and the plate thickness difference in the width direction of the strip S are examples of material parameters of the strip S related to the individual of the strip S. The long lifetime part parameter and the short lifetime part parameter are equipment parameters related to the state of the rolling mill 100.

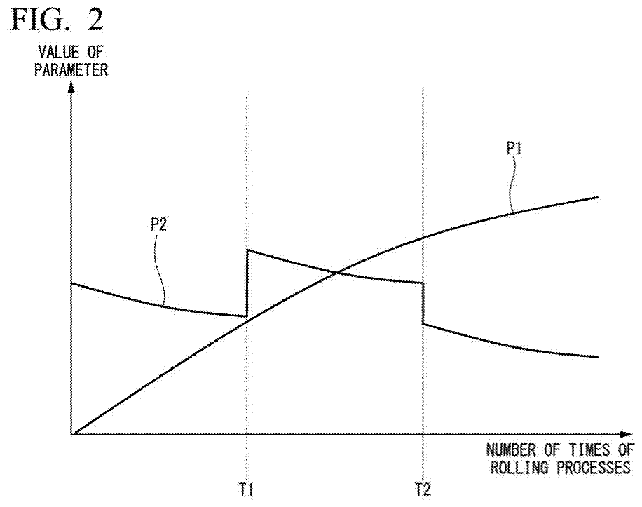

FIG. 2 is a diagram showing a difference between fluctuation characteristics of the long lifetime part parameter and the short lifetime part parameter. The long lifetime part parameter P1 monotonously increases with the number of rolling processes regardless of the timing of the roll replacement. On the other hand, the short lifetime part parameter P2 discontinuously changes at the roll replacement timings T1 and T2.

These material parameter and equipment parameter are difficult to determine by measurement. The material parameter and the equipment parameter are treated as unknown driving conditions.

As described above, since each strip S has different properties, the rolling mill 100 processes the strip S having different properties for each time zone.

### Constitution of Diagnosis Device

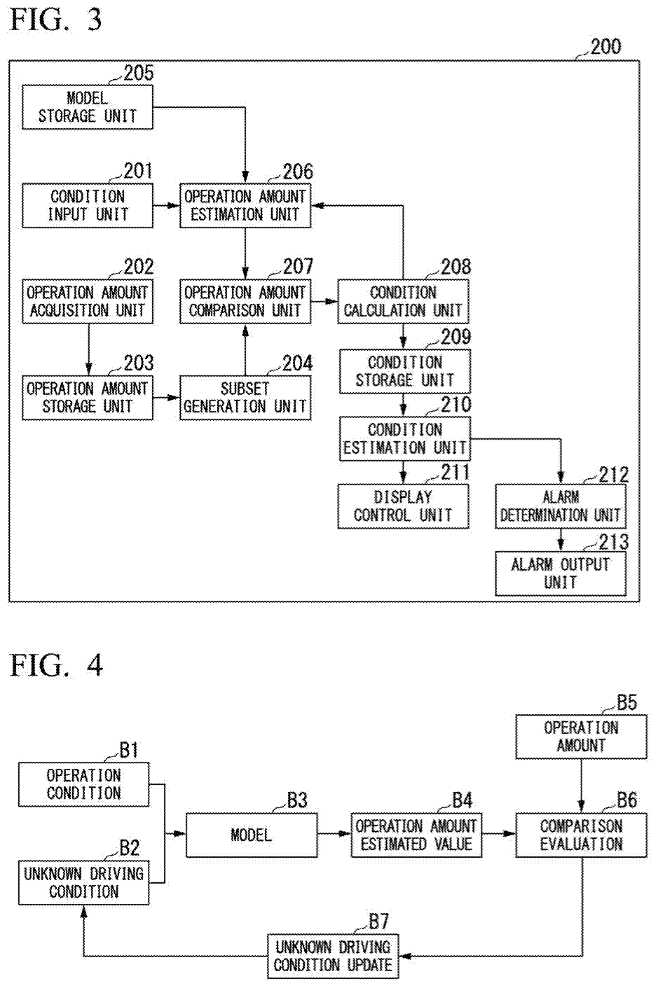

FIG. 3 is a schematic block diagram showing a software constitution of the diagnosis device.

The diagnosis device 200 includes a condition input unit 201, an operation amount acquisition unit 202, an operation amount storage unit 203, a subset generation unit 204, a model storage unit 205, an operation amount estimation unit 206, an operation amount comparison unit 207, a condition calculation unit 208, a condition storage unit 209, a condition estimation unit 210, a display control unit 211, an alarm determination unit 212, and an alarm output unit 213.

The condition input unit 201 receives an input of an operation condition of the rolling mill 100 as the known driving condition. Examples of the operation condition may include the plate width of the strip S, a thickness of an input side of the strip S, a pressure rate of the rolling mill 100, and the rolling load of the rolling mill 100. The parameter of the strip S included in the operation condition is a reference value that is independent of individual difference of the strip S. The known driving condition related to other embodiments is not limited to the operation condition.

The operation amount acquisition unit 202 acquires measurement values of the stroke amounts of the right pressure cylinder 110 and the left pressure cylinder 111 from the right stroke sensor 112 and the left stroke sensor 113, respectively, and obtains a difference between the left and right stroke amounts of the pressure cylinder (hereinafter referred to as leveling), that is, an actual measurement value of the operation amount, on the basis of the measurement values, in a steady state of the rolling mill 100. The operation amount acquisition unit 202 records the actual measurement value of the operation amount in the operation amount storage unit 203 for each rolling process. For example, the operation amount storage unit 203 stores the actual measurement value of the operation amount at the time of generation of a rolling coil in association with a serial number of the rolling coil generated by the rolling process. That is, the operation amount acquisition unit 202 is an example of a sampling unit that samples the actual measurement value related to a driving result during a period of driving under the known driving condition in order to process a material having different properties for each time zone.

The subset generation unit 204 generates a plurality of subsets among a plurality of the actual measurement values of operation amounts stored in the operation amount storage unit 203. The subset of the actual measurement values is a combination of the actual measurement values of which the number is less than the number of samples of the actual measurement values. For example, when the operation amount storage unit 203 stores the actual measurement values of the operation amounts for each of fifty rolling coils generated during a certain period, the subset generation unit 204 generates the subsets by randomly selecting forty actual measurement values among fifty actual measurement values. For example, the subset generation unit 204 generates subsets of 200 different combinations of the actual measurement values by repeating the generation of the subset 200 times.

The model storage unit 205 stores a model for obtaining the operation amount of the rolling mill 100 for controlling the strip so that the meandering does not occur in the strip S to the basis of the known driving condition and the unknown driving condition.

The model stored in the model storage unit 205 may be a physical model representing a structure of the rolling mill 100, may be a simplified model represented by a mathematical expression having the known driving condition and the unknown driving condition as variables, or may be a learned model that is machine-learned on the basis of previously collected training data.

The operation amount estimation unit 206 estimates the leveling between the left and right of the pressure cylinders of the rolling mill 100, that is, the leveling of right pressure cylinder 110 and the left pressure cylinder 111 by inputting the known driving condition that is input to the condition input unit 201 and the unknown driving condition that is calculated by the condition calculation unit 208 to the model stored in the model storage unit 205. The leveling between the left and right of the pressure cylinders is an example of the operation amount of the rolling mill 100 by the operator.

The operation amount comparison unit 207 compares the estimated value of the operation amount specified by the operation amount estimation unit 206 with the actual measurement value of the operation amount acquired by the operation amount acquisition unit 202, and calculates a magnitude of an error of the estimated value.

The condition calculation unit 208 calculates each unknown driving condition so that the difference between the estimated value and the actual measurement value is reduced. That is, the condition calculation unit 208 adjusts the value of each unknown driving condition input to the operation amount estimation unit 206 so that the difference between the estimated value and the actual measurement value is reduced.

The condition storage unit 209 stores the value of the unknown driving condition calculated by the condition calculation unit 208 for each subset.

The condition estimation unit 210 estimates the value of each unknown driving condition on the basis of statistic of the value of each unknown driving condition stored in the condition storage unit 209. Specifically, the condition estimation unit 210 generates a histogram for each unknown driving condition, and estimates the value of each unknown driving condition on the basis of a mode in the histogram. Therefore, the number of the subsets generated by the subset generation unit 204 is preferably the number sufficient to specify the mode.

The display control unit 211 causes the display 220 to display the value of each unknown driving condition estimated by the condition estimation unit 210.

The alarm determination unit 212 determines whether or not the unknown driving condition is equal to or greater than a threshold value.

The alarm output unit 213 outputs an alarm notifying the abnormality of the rolling mill 100 when the unknown driving condition is equal to or greater than the threshold value.

### Outline of Diagnostic Process

FIG. 4 is a block diagram showing an outline of equipment diagnosis.

The diagnosis device 200 obtains an estimated value B4 of the operation amount by inputting a known driving condition B1 and an unknown driving condition B2 into a model B3. The diagnosis device 200 performs comparative evaluation B6 on the estimated value B4 of the operation amount and an actual measurement value B5 of the operation amount. The diagnosis device 200 updates B7 the unknown driving condition B2 on the basis of a result of the comparative evaluation. By repeatedly executing this, the diagnosis device 200 is able to set the unknown driving condition B2 to a value close to an actual condition.

### Operation of Diagnosis Device

More specifically, the diagnosis device 200 executes the following diagnosis process at the work roll or work roll and backup roll replacement timing.

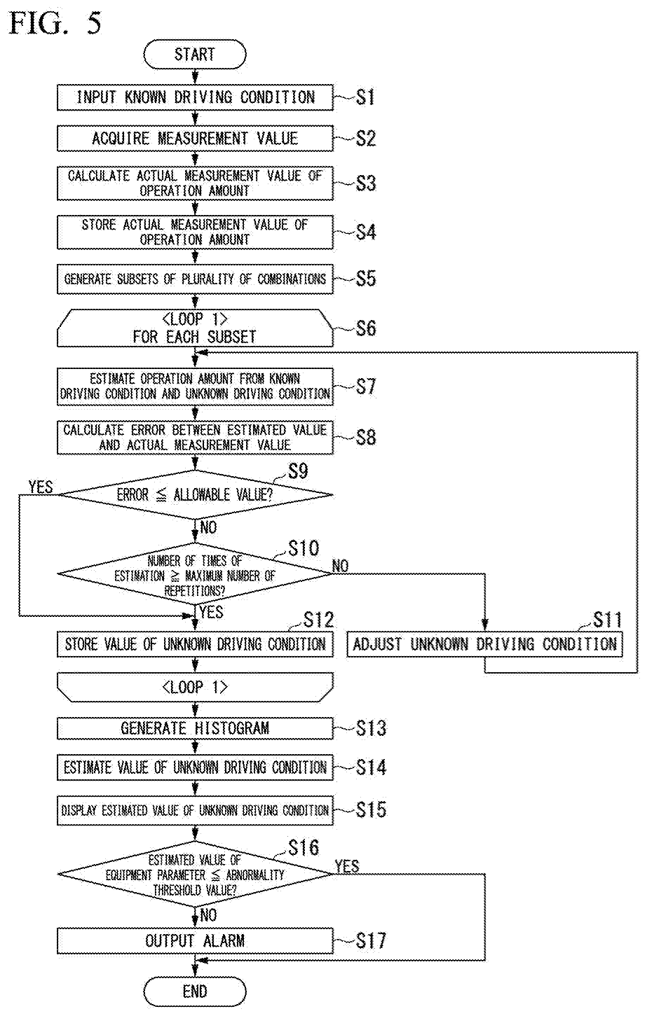

FIG. 5 is a flowchart showing the diagnosis process of the rolling mill by the diagnosis device according to the first embodiment.

First, the condition input unit 201 receives an input of the known driving condition from the operator or a control device (not shown) of the rolling mill 100 (step S1). In addition, the operation amount acquisition unit 202 acquires a time series of a measurement value of the right stroke sensor 112 and a time series of a measurement value of the left stroke sensor 113 between the previous replacement timing and the current replacement tinting (step S2). The operation amount acquisition unit 202 calculates a difference between the measurement value of the right stroke sensor 112 and the measurement value of the left stroke sensor 113 at each time to calculate a time series of the leveling between the left and right, that is, a time series of the actual measurement value of the operation amount (step S3). The operation amount acquisition unit 202 records the calculated time series of the actual measured value in the operation amount storage unit 203 (step S4). At this time, the operation amount acquisition unit 202 divides the time series of the actual measurement value of the operation amount into the time zone in which N rolling coils are generated, and records a value related to a steady portion in the divided time series in the operation amount storage unit 203 in association with serial numbers of the N rolling coils. Note that, in another embodiment, the operation amount storage unit 203 may also store the time series of the actual measurement value of the operation amount for each rolling coil.

Next, the subset generation unit 204 generates L subsets of the actual measurement values including M actual measurement values that are randomly extracted from the actual measurement values of the operation amount stored in the operation amount storage unit 203 (step S5). At this time, M and L are integers that satisfy _{N}C_{M}>L.

The diagnosis device 200 selects the subsets generated by the subset generation unit 204 one by one (step S6), and executes the following process from steps S7 to S12 for each of the selected subsets.

First, the operation amount estimation unit 206 inputs the known driving condition that is input to the condition input unit 201 and the unknown driving condition that is calculated by the condition calculation unit 208 to the model stored in the model storage unit 205 and obtains the estimated value of the operation amount (step S7). Note that, when an initial value of the unknown driving condition is not determined by the condition calculation unit 208, the operation amount estimation unit 206 determines the initial value of the unknown driving condition by a random number. The unknown driving condition input to the model is the value of the unknown driving condition for each rolling coil related to the subset. In addition, the estimated value of the operation amount obtained from the model is the value or the operation amount for each rolling coil related to the subset.

The operation amount comparison unit 207 compares the estimated value of the operation amount specified by the operation amount estimation unit 206 with the actual measurement value of the operation amount acquired by the operation amount acquisition unit 202 to calculate the error of the estimated value (step S8). The operation amount comparison unit 207 determines whether or not the error of the calculated estimated value is equal to or less than a predetermined allowable value (step S9). When a magnitude of the error is greater than the allowable value (step S9: NO), the operation amount estimation unit 206 determines whether or not the number of times of the estimation calculation of the operation amount in step S7 is equal to or greater than a predetermined maximum number of repetitions (step S10).

When the number of times of the estimation calculation of the operation amount is less than the maximum number of repetitions (step S10: NO), the condition calculation unit 208 adjusts the value of the unknown driving condition of each rolling coil related to the subset so that the difference between the estimated value and the actual measurement value is reduced (step S11). As a method of adjusting the unknown driving condition, there is a global optimization method.

Incidentally, it is known that among the unknown driving conditions, the wear amount of the roll chock and the rigidity difference between the left and right of the roll have the same sensitivity to the estimated value of the operation amount. On the other hand, it is known that the rigidity difference between the left and right of the roll is caused by the installation state of the backup roll. Therefore, when the backup roll is not replaced, the condition calculation unit 208 sets the rigidity difference between the left and right of the toll as a constant value, and adjusts the value related to the amount of the wear of the roll chock and the deviation amount of the installation position of the roll.

In addition, the diagnosis device 200 returns the process to step S7, and estimates the operation amount again on the basis of the unknown driving condition after the adjustment.

On the other hand, when the magnitude of the error is equal to or less than the allowable value (step S9: YES), or when the number of times of the estimation calculation is greater than or equal to the maximum number of repetitions (step S10: YES), the condition calculation unit 208 records the value of the calculated unknown driving condition in the condition storage unit 209 in association with the ID of the subset (step S12).

When the unknown driving conditions are calculated for all the subsets by the processes of steps S6 to S12 described above, the condition estimation unit 210 generates a histogram for each item of the unknown driving conditions (step S13). Specifically, for each of the wear amount of the roll chock, the rigidity difference between the left and right of the roll, the deviation of the installation position of the roll, the temperature difference in the width direction of the strip S, the meandering amount of the strip S, and the plate thickness difference in the width direction of the strip S, the condition estimation unit 210 generates the histogram based on the values that are calculated for subset stored in the condition storage unit 209. The condition estimation unit 210 estimates the mode of the histogram in each item of the unknown driving condition as the value of the unknown driving condition according to the item (Step S14).

The display control unit 211 outputs a screen that displays the values of each estimated unknown driving condition on the display (step S15). The value of the unknown driving condition may be displayed as a graph or may be displayed as a number.

Among the estimated unknown driving conditions, the alarm determination unit 212 compares each value (the wear amount of the roll chock, the rigidity difference between the left and right of the roll, the deviation of the installation position of the roll) related to the equipment parameter with an abnormality threshold value of each equipment parameter, and determines whether or not all of the estimated values of the equipment parameters are equal to or less than the abnormality threshold value (step S16). When any of the estimated values of the equipment parameter is greater than the abnormality threshold value (YES in step S16), the alarm output unit 213 outputs an alarm indicating that there is an abnormality in the equipment parameter that is greater than the abnormality threshold value (step S17), and ends the diagnosis process. The alarm may be displayed on the display, may be output from a speaker, or may be transmitted by communication. In addition, when all the estimated values of the equipment parameters are equal to or less than the abnormality threshold value (step S16: NO), the alarm output unit 213 ends the diagnosis process without outputting the alarm.

### Operation and Effect

As described above, according to the first embodiment, the diagnosis device 200 acquires the estimated value related to the driving result from the value of the known driving condition and the value of the unknown driving condition, and estimates the value of the unknown driving condition so that the difference between the estimated value and the actual measurement value related to the driving result in the period of driving under the known driving condition is reduced.

Therefore, the diagnosis device 200 is able to estimate the unknown driving condition of an object by suppressing the influence of the parameter having the variation including the property of the strip S.

In addition, according to the first embodiment, the diagnosis device 200 generates the plurality of sets of subsets that are a combination of the plurality of actual measurement values, calculates the value of the unknown driving condition so that the difference between the actual measurement value of the driving result and the estimated value of the driving result is reduced for each subset, and estimates the value of the unknown driving condition on the basis of the statistic thereof. Specifically, according to the first embodiment, the diagnosis device 200 generates the histogram on the basis of the value of the unknown driving condition for each subset, and estimates the value of the unknown driving condition on the basis of the mode of the histogram.

Therefore, even when the calculation result of the value of one unknown driving condition includes the influence of the variation of the other unknown driving condition such as the material parameter, it is possible to reduce the influence by estimating the value of the unknown driving condition on the basis of the mode of the histogram.

Note that, the diagnosis device 200 according to the first embodiment estimates the value of the unknown driving condition on the basis of the mode of unknown driving condition, but is not limited thereto. For example, when the calculation results of the unknown driving conditions are distributed as normal distribution or the like in another embodiment, the diagnosis device 200 may estimate the value of the unknown driving condition on the basis of an average value of the unknown driving conditions. In addition, in another embodiment, the value of the unknown driving condition may be estimated on the basis of other statistics such as a median of the unknown driving condition.

In addition, according to the first embodiment, the diagnosis device 200 executes the diagnosis process at a timing after the completion of the data collection before regular device replacement. Therefore, the operator is able to recognize the state of the target device related to the current operation by visually recognizing the value of the unknown driving condition displayed on the display 220. Thus, the operator is able to replace the device at an appropriate timing.

In addition, according to the first embodiment, the diagnosis device 200 outputs the alarm by comparing the estimated value of the unknown driving condition with a predetermined threshold value. Therefore, the diagnosis device 200 is able to notify the operator of the presence or absence of the abnormality based on the unknown driving condition. In particular, the diagnosis device 200 is able to appropriately notify a replacement time of a long lifetime part by outputting an alarm on the basis of a long lifetime part parameter such as the wear amount of the roll chock among the unknown driving conditions. In addition, the rigidity difference between the left and right of the roll is due to an installation condition of the backup roll, and a replacement frequency of the backup roll is less than a replacement frequency of the work roll. Therefore, the diagnosis device 200 is able to promote measures such as performing adjustment of the backup roll together with the replacement of the work roll by outputting an alarm related to the rigidity difference between the left and right of the roll at the replacement timing of the work roll. In addition, the diagnosis device 200 is able to prompt an appropriate installation of the roll to a replacement operator by outputting an alarm related to a position deviation amount of the roll.

In addition, the diagnosis device 200 according to the first embodiment estimates the value related to the driving result from the operation condition on the basis of the model. Therefore, even the operator does not have equipment diagnosis know-how, it is possible to automatically estimate the value related to the driving result by optimization utilizing the model. In addition, the model is not limited to a physical model, and may be a simple model or a machine learning model. It is possible to reduce a time required to build the model by using the simple model or the machine learning model.

### Other Embodiments

As described above, although one embodiment was described in detail with reference to drawings, a concrete constitution is not limited to the above-described embodiment, and various design changes and the like can be made.

In the embodiments described above, the diagnosis device 200 estimates the unknown driving condition using the leveling as the driving result, but is not limited thereto. For example, when the diagnosis device 200 according to the other embodiments includes load meters (a right load detector 114 and a left load detector 115) on left and right of an axis of a lower backup roll 109 below the lower backup roll 109, the diagnosis device 200 according to the other embodiments may estimate the unknown driving condition using a difference between a value of the right load detector 114 and a value of the left load detector 115 as the driving result instead of the leveling between the left and right. In addition, the diagnosis device 200 according to the other embodiments may estimate the unknown driving condition using both of the leveling between the left and right and the difference between the value of the right load detector 114 and the value of the left load detector 115. Note that, when the diagnosis device 200 estimates the unknown driving condition using the difference between the values of the left and right load meters as the driving result, the model stored in the model storage unit 205 is required to be a model for outputting the difference between the values of the left and right load meters by inputting the operation condition.

In the embodiments described above, the diagnosis device 200 estimates the unknown driving condition by using the rolling mill 100 as the target device, but is not limited thereto. For example, in other embodiments, a biochemical power plant based on biochemical gasification may be the target device. In this case, the diagnosis device 200 is able to estimate, for example, a type of biomass, a state of microorganism in a fermenter, and the like as the unknown driving condition by using a power generation amount or a generated amount of biogas as the driving result and using a mass of a biomass as the known driving conditions. In addition, for example, in other embodiments, a heat exchanger of a waste heat recovery boiler may be the target device. In this case, the diagnosis device 200 is able to estimate, for example, a soot adhesion amount in the heat exchanger, and the like as the unknown driving condition by using an outlet temperature of the heat exchanger as the driving result and using an operation condition of an internal combustion engine of a previous stage as the known driving condition.

In the embodiments described above, the diagnosis device 200 that is an example of the estimation device estimates the unknown driving condition of the rolling mill 100, and outputs the alarm on the basis of the estimation result, but is not limited thereto. For example, in other embodiments, instead of the diagnosis device 200, an estimation device that estimates the unknown driving condition of the rolling mill 100 and does not output the alarm may be provided.

In the embodiments described above, the diagnosis device 200 estimates the unknown driving condition on the basis of the value of the steady portion of the operation amount, but is not limited thereto. For example, the diagnosis device 200 may obtain a time series of the estimated value of the operation amount on the basis of the time series of the actual measurement values of the respective rolling coils to estimate the unknown driving condition on the basis of the time series of the estimated value. In this case, the unknown driving condition input to the model is a time series of the unknown driving condition for each rolling coil related to the subset, and the estimated value of the operation amount obtained from the model is a time series of the operation amount for each rolling coil related to the subset. In addition, in this case, the diagnosis device 200 is able to obtain the error between the estimated value and the actual measurement value by a least square error between the time series of the estimated value and the time series of the actual measurement value.

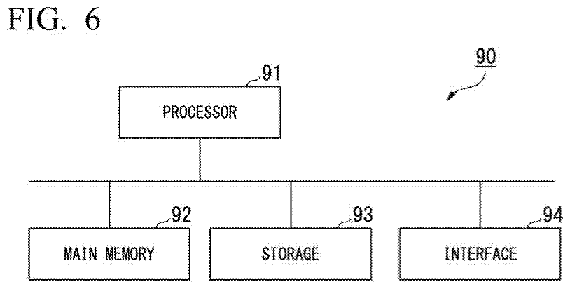

FIG. 6 is a schematic block diagram showing a constitution of a computer according to at least one embodiment.

The computer 90 includes a processor 91, a main memory 92, a storage 93, and an interface 94.

The above-described diagnosis device 200 is mounted in the computer 90. In addition, the operation of each processing unit described above is stored in the storage 93 in a form of a program. The processor 91 reads the program from the storage 93, develops the program in the main memory 92, and executes the processed described above in accordance with the program. In addition, the processor 91 secures, in the main memory 92, a storage area corresponding to each storage unit described above in accordance with the program.

Examples of the storage 93 include a hard disk drive (HDD), a solid state drive (SSD), a magnetic disk, an optical magnetic disk, a compact disc read only memory (CD-ROM), and a digital versatile disc read only memory (DVD-ROM), a semiconductor memory, and the like. The storage 93 may be internal media directly connected to a bus of the computer 90 or may be external media connected to the computer 90 through the interface 94 or a communication line. In addition, when the program is distributed to the computer 90 by the communication line, the computer 90 that has received the distribution may develop the program in the main memory 92 and execute the processes described above. In at least one embodiment, the storage 93 is a non-transitory tangible storage medium.

In addition, the program may be for realizing part of the functions described above. Furthermore, the program may be a so-called difference file (difference program) that realizes the above-described function in combination with other programs already stored in the storage 93.

### REFERENCE SIGNS LIST

1 Rolling system

100 Rolling mill

101 Housing

102 Upper work roll chock

103 Lower work roll chock

104 Upper work roll

105 Lower work roll

106 Upper backup roll chock

107 Lower backup roll chock

108 Upper backup roll

109 Lower backup roll

110 Right pressure cylinder

111 Left pressure cylinder

112 Right stroke sensor

113 Left stroke sensor

114 Right load detector

115 Left load detector

200 Diagnosis device

201 Condition input unit

202 Operation amount acquisition unit

203 Operation amount storage unit

204 Subset generation unit

205 Model storage unit

206 Operation amount estimation unit

207 Operation amount comparison unit

208 Condition calculation unit

209 Condition storage unit

210 Condition estimation unit

211 Display control unit

212 Alarm determination unit

213 Alarm output unit

S Strip

What is claimed is:

1. An estimation device that estimates a value of an unknown driving condition of a target device on the basis of a value of a known driving condition of the target device, the estimation device comprising:
a sampling unit configured to sample an actual measurement value related to a driving result during a period of a driving under the known driving condition in order to process a material having different properties for each time zone;
a driving result estimation unit configured to obtain an estimated value related to the driving result from the value of the known driving condition and the value of the unknown driving condition; and
a condition estimation unit configured to estimate the value of the unknown driving condition so that a difference between the actual measurement value related to the driving result and the estimated value related to the driving result is reduced.

2. The estimation device of claim 1, further comprising:
a subset generation unit configured to generate a plurality of subsets that from a plurality of the sampled actual measurement values, the plurality of subsets is a combination of the actual measurement values of which the number is less than the number of the sampled actual measurement values; and
a condition calculation unit configured to calculate the value of the unknown driving condition so that the difference between the actual measurement value related to the driving result and the estimated value related to the driving result is reduced, for each subset,
wherein the condition estimation unit estimates the value of the unknown driving condition on the basis of statistic of the value of the unknown driving condition calculated for each subset.

3. The estimation device of claim 2,
wherein the condition estimation unit generates a histogram on the basis of the value of the unknown driving condition calculated for each subset, and estimates the value of the unknown driving condition on the basis of a mode of the histogram.

4. The estimation device of claim 1, further comprising:
an alarm output unit configured to output an alarm by comparing the estimated value of the unknown driving condition with a predetermined threshold value.

5. The estimation device of claim 1,
wherein the condition estimation unit estimates the value of the unknown driving condition on the basis of the actual measurement value sampled between a previous replacement timing and a current replacement timing in a timing when a part of the target device is replaced.

6. The estimation device of claim 1,
wherein the driving result estimation unit obtains the estimated value related to the driving result by inputting the value of the known driving condition and the value of the unknown driving condition to a model that obtains the driving results on the basis of the known driving condition and unknown driving condition.

7. The estimation device of claim 1,
wherein the target device is a rolling mill that rolls a rolling target by a roll,
the unknown driving condition includes a parameter related to a state of the target device and a parameter related to an individual of the rolling target, and
the driving result is a parameter related to an operation amount for tilting the roll.

8. The estimation device of claim 7,
wherein the driving result includes at least one of leveling of left and right of the roll, and a load applied to the left and right of the roll.

9. An estimation system comprising:
the estimation device of claim 1; and
a display device configured to display the value of the unknown driving condition estimated by the estimation device.

10. An estimation method of estimating a value of an unknown driving condition of a target device on the basis of a known driving condition of the target device, the estimation method comprising the steps of:
sampling an actual measurement value related to a driving result during a period of a driving under the known driving condition in order to process a material having different properties for each time zone;
obtaining an estimated value related to the driving result from the value of the known driving condition and the value of the unknown driving condition; and
estimating the value of the unknown driving condition so that a difference between the actual measurement value related to the driving result and the estimated value related to the driving result is reduced.

11. A non-transitory tangible storage medium storing a program that causes a computer to execute the steps of:
sampling an actual measurement value related to a driving result during a period of a driving under a known driving condition of a target device in order to process a material having different properties for each time zone;
obtaining an estimated value related to the driving result of a target device from a value of the known driving condition and a value of an unknown driving condition of the target device; and
estimating the value of the unknown driving condition so that a difference between the actual measurement value related to the driving result and the estimated value related to the driving result is reduced.
